(19) United States
(12) Patent Application Publication
(10) Pub. No.: US 2012/0208929 A1
(43) Pub. Date: Aug. 16, 2012

(54) RESIN COMPOSITION

(75) Inventors: Der-Gun Chou, Taoyuan (TW); Wen-Jeng Lee, Taoyuan (TW); Ta-Ming Liu, Taoyuan (TW); Tsung-Yi Chao, Taoyuan (TW)

(73) Assignee: EVERLIGHT USA, INC., Pineville, NC (US)

(21) Appl. No.: 13/371,529

(22) Filed: Feb. 13, 2012

(30) Foreign Application Priority Data
Feb. 15, 2011 (TW) 100104867

(51) Int. Cl. C08L 63/00

(52) U.S. Cl. 523/456

(57) ABSTRACT

A resin composition for LED encapsulation is provided. The resin composition includes an epoxy resin, a curing agent and a stress adjusting agent. The resin composition of the present invention improves reliability of LED products and meets requirements in industry.

### 1. FIELD OF INVENTION

The present invention relates to a resin composition, and more particularly, to a resin composition for LED encapsulation.

2. BACKGROUND OF THE INVENTION

A light emitting diode (LED) is a solid-state light source, and has low power consumption and long lifespan. An LED also has small volume, great tolerance to shakes and difference colors. An LED is widely used in various applications such as home equipment, computer equipment, communication products, traffic lights and automobile light sources due to the improvement of materials and encapsulation technology. The global market sale of LED has increased 10.3% in 2009 than that in 2008. It predicts that the global market sale of LED would keep increasing.

Currently, the silicon-typed encapsulation material is the major material for high level of LED encapsulation, but is expensive. Therefore, encapsulation materials such as epoxy resin are developed for reducing the cost of encapsulation. Epoxy resin has great electric insulation, mechanical property and adhesive property, and is thus used in semiconductor encapsulation, varnish for printed circuit boards and resist materials. However, the epoxy resin has higher coefficients of thermal expansion (CTE), internal stress occurs during curing, so as to result in cracks, poor adhesiveness, internal disconnection and decrease in luminance (especially for infrared ray and yellow LEDs). The product reliability is thus reduced.

To improve the product reliability, U.S. Pat. No. 5,145,889 discloses the following methods for reducing internal stress in encapsulation materials. (1) The glass transition temperature (T_{g}) is reduced by increasing elasticity and reducing crosslinking density; (2) the linear expansion coefficient (c) is reduced by adding a filler in resin, wherein the filler may be an inorganic filler such as particulate silica, ground quartz and aluminium nitride; (3) Young's modulus of elasticity is reduced by forming the resin with sea and island structure; and (4) the shrinkage factor (c) is reduced by uniform progress of resin curing. JP 2009-191170 discloses an epoxy resin composition having an epoxy resin, a curing agent and polyalkylene glycol with weight average molecular weight of 300 to 1000, and having great crack resistance. Further, Taiwanese Patent Application No. 098128474 discloses introducing carbinol siloxane resin for decreasing hardness of the epoxy resin composition and reducing internal stress during curing. In order to meet requirements of industry, there is still a need to develop an encapsulation material for reducing stress and increasing reliability.

### SUMMARY OF THE INVENTION

The present invention provides a resin composition including 43 to 53 wt % of an epoxy resin based on total weight of the resin composition; 40 to 47 wt % of a curing agent based on the total weight of the resin composition; and 0.5 to 10 wt % of a stress adjusting agent based on the total weight of the resin composition, wherein the stress adjusting agent is one or more selected from the group consisting of ethylene glycol, propylene glycol, polyethylene glycol, polypropylene glycol and polytetramethylene ether glycol.

According to an embodiment of the present invention, the epoxy resin is one or more selected from the group consisting of bisphenol A epoxy resin, silicon-containing epoxy resin and aliphatic epoxy resin. The weight average molecular weight of the epoxy resin is 200 to 3000, and preferably 300 to 900. According to an embodiment of the present invention, the stress adjusting agent is ethylene glycol, propylene glycol or a combination thereof. According to an embodiment of the present invention, the stress adjusting agent is one or more selected from the group consisting of polyethylene glycol, polypropylene glycol and polytetramethylene ether glycol, and has weight average molecular weight of 1500 to 3000. For example, the stress adjusting agent is polyethylene glycol, and weight average molecular weight of the polyethylene glycol is 1500 to 3000. Alternatively, the stress adjusting agent is polypropylene glycol, and weight average molecular weight of the polypropylene glycol is 2000 to 3000. The stress adjusting agent is polytetramethylene ether glycol, and weight average molecular weight of the polytetramethylene ether glycol is 1800 to 3000. One or more of the above stress adjusting agent may be used. According to an embodiment of the present invention, the resin composition further includes a catalyst. According to an embodiment of the present invention, the resin composition further includes an additive.

### DETAILED DESCRIPTION OF THE PREFERED EMBODIMENTS

The following specific examples are used for illustrating the present invention. A person skilled in the art can easily conceive the other advantages and effects of the present invention.

The term “weight average molecular weight” herein refers to the weight average molecular weight (Mw) value of polystyrene calculated from the measurement using tetrahydrofuran (THF) for gel permeation chromatography (GPC).

In the resin composition of the present invention, the epoxy resin may be, but not limited to, one or more selected from the group consisting of aromatic epoxy resin, silicon-containing epoxy resin and aliphatic epoxy resin. The aromatic epoxy resin may be bisphenol A diglycidyl ether resin (NPEL-127E, NPEL-128E from Nan Ya Plastics Corporation) or bisphenol F epoxy resin. The aliphatic epoxy resin may be cycloaliphatic glycidyl ether epoxy resin (such as NPEX-102 from Nan Ya Plastics Corporation) or 3,4-epoxycyclohexyl methyl-3,4-epoxycyclohexanecarboxylate (such as ERL-4221 from Dow Chemical Corporate). The silicon-containing epoxy resin may be the compound of formula (I):

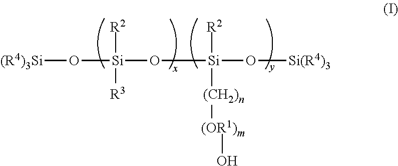

In the formula (I), R¹ is a linear or branched alkyl group such as —C₂H₄—, —C₃H₆— or —C₄H₈—. When m is 1, (OR¹)ₘ is an alkoxy group, and when m is more than 1, (OR¹) is polycycloalkoxy, wherein when m is more than 1, all (OR¹) may be the same or different, and form monomers, irregular polymers or block polymers. R² and R³ are independently hydrogen or C₁₋₂alkyl; R⁴ is hydrogen or C₁₋₂alkyl; x is an integer from 1 to 100; y is an integer from 1 to 100; n is an integer from 1 to 5; and m is an integer from 1 to 40. In one embodiment, R² and R⁴ are both methyl.

In the present invention, the epoxy resin is preferably one or more selected from the group consisting of bisphenol A epoxy resin, silicon-containing epoxy resin and aliphatic epoxy resin. In one embodiment, the epoxy resin is bisphenol A epoxy resin. Generally, the weight average molecular weight of bisphenol A epoxy resin is 200 to 3000. In one embodiment, the weight average molecular weight of bisphenol A epoxy resin is 300 to 900. According to one embodiment, the resin composition includes 43 to 53 wt %, preferably 45 to 52 wt %, and more preferably 49 to 50 wt %, of the epoxy resin based on the total weight of the resin composition.

In the resin composition of the present invention, the curing agent may be an anhydride curing agent. The anhydride curing agent may be, but not limited to, methyl hexahydrophthalic anhydride (MHHPA; 4-MHHPA), 1,3-dioxo-1,3-dihydro-2-benzofuran-5-carboxylic acid, hexahydrophthalic anhydride (HHPA), tetrahydrophthalic anhydride, 1,2,4,5-benzenetetracarboxylic anhydride, 3,3′,4,4′-biphenyltetracarboxylic anhydride or a combination thereof. According to one embodiment of the present invention, methylhexahydrophthalic anhydride and/or 1,3-dioxo-1,3-dihydro-2-benzofuran-5-carboxylic acid may be used as the curing agent in the resin composition. According to one embodiment, the resin composition includes 40 to 47 wt %, preferably 42 to 46 wt %, and more preferably 43 to 45 wt %, of the curing agent based on the total weight of the resin composition.

The stress adjusting agent may be, but not limited to, ethylene glycol (EG), polyethylene glycol (PEG), propylene glycol (PG), polypropylene glycol (PPG), polytetramethylene ether glycol (PTMG), polytetraethylene glycol or polypentaethylene glycol, polyhexaethylene glycol. One or more of the above stress adjusting agents may be used in the resin composition of the present invention. In one embodiment of the present invention, the stress adjusting agent may be one or more selected from ethylene glycol, propylene glycol, polyethylene glycol, polypropylene glycol and polytetramethylene ether glycol. According to one embodiment of the present invention, the stress adjusting agent is ethylene glycol, propylene glycol or a combination thereof. According to one embodiment of the present invention, the stress adjusting agent is one or more selected from the group consisting of polyethylene glycol, polypropylene glycol and polytetramethylene ether glycol, and the weight average molecular weight of the stress adjusting agent is 1500 to 3000. In one embodiment, the stress adjusting agent is polyethylene glycol, and the weight average molecular weight of polyethylene glycol is 1500 to 3000. In one embodiment, the stress adjusting agent is polypropylene glycol, and the weight average molecular weight of polypropylene glycol is 2000 to 3000. In one embodiment, the stress adjusting agent is polytetramethylene ether glycol, and the weight average molecular weight of polytetramethylene ether glycol is 1800 to 3000. According to one embodiment, the resin composition includes 0.5 to 10 wt %, preferably 0.5 to 7 wt %, and more preferably 0.5 to 6 wt %, of the stress adjusting agent based on the total weight of the resin composition.

The resin composition of the present invention includes a catalyst. The catalyst may be, but not limited to, a tertiary amine, a tertiary amine salt, a quaternary ammonium salt (such as tetraethyl ammonium bromide or tetra-n-butylammonium bromide), an imidazole, a diazabicycloene and its salt, a phosphate (such as tetra-ethylphosphonium bromide, tetra-n-butylphosphonium bromide, methyltributyltriphenylphosphonium iodide, methyl tri-n-butylphosphonium dimethylphosphate or tetra-ethylphosphonium tetrafluoroborate), a boron compound, an alcohol, a metal salt or an organic metal complex. According to one embodiment of the present invention, tetraethyl ammonium bromide, methyl tri-n-butylphosphonium dimethylphosphate or a combination thereof may be used as a catalyst. According to one embodiment of the present invention, the resin composition includes 0.5 to 5 wt %, preferably 0.5 to 3 wt %, and more preferably 0.6 to 1 wt %, of the catalyst based on the total weight of the resin composition.

The resin composition of the present invention may include an additive. The additive may be, but not limited to, a UV absorber, a stabilizer, an antioxidant, a pigment, a dye, a filler, a modifier, a toughener, a defoamer, a dispersant, a leveling agent, a thickening agent, a reinforcing agent, a coupling agent, a flexibility-imparting agent, a plasticizer, a sensitizer, water, an anti-settling agent or a combination thereof.

The UV absorber may be, but not limited to, the compounds having the following formula:

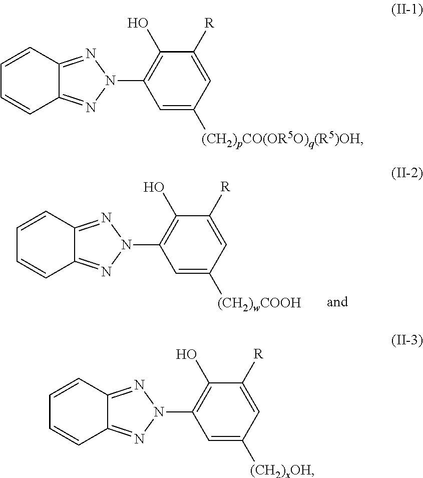

wherein p, q, w and x are independently integers from 1 to 5; R is hydrogen or C₁₋₈alkyl; and R⁵ is a linear or branched C₂₋₄aklkyl. For example, benzenepropanoic acid (EV81, Everlight Chemical Industrial Corporation), 3-(2H-benzotriazole-2-yl)-5-(1,1-di-methylethyl)-4-hydroxy-, C7-C9-branched and linear alkyl esters+1-methoxy-2-propyl acetate may be used as the UV absorber.

The hindered amine (HALS) having the formula (HI) may be used as a stabilizer:

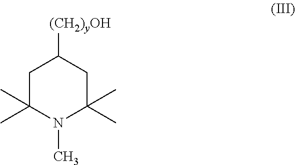

wherein y is an integer from 0 to 8.

For example, triphenylphosphite (TPP) may be used as the stabilizer.

In one embodiment, the resin composition includes no more than 10 wt % of the additive based on the total weight of the resin composition.

According to an embodiment of the present invention, the resin composition may be used in LED encapsulation.

The resin composition of the present invention may reduce the occurrence of stress, so as to improve reliability of LED products and meet the requirements of the industry.

The present invention is more specifically illustrated, but not limited by, the following embodiments. The amount of each component presented as “%” or “weight part” in embodiments and comparative examples is based on weight.

### Embodiments

Test Methods

(1) Thermomechanical Analysis (TMA)

The cured gel was cut into pieces (3 cm×1.5 cm×0.5 cm) by a diamond cutter for thermomechanical analysis, and the pieces were specimens analyzed by the TMA machine (Perkin Elmer DMA/TMA 7e). The specimens were heated to 320° C. at the rate of 10° C./min, and analyzed to obtain the curve of the expansion coefficient. One or two TMAs may be performed. Then, the glass transition temperature (T_{g}) was obtained. The slope of the expansion coefficient curve before T_{g} was presented as α₁, and the slope of the expansion coefficient curve after T_{g} was presented as α₂. In the LED industry, α₂/α₁ is required to be less than 3 or even less than 2.5.

(2) Differential Scanning Calorimeter (DSC)

The cured gel was broken into pieces (0.1 cm×0.1 cm×0.1 cm; 4-10 mg) by a breaker, and the pieces were analyzed by the DSC machine (Mettler D823 and NETZsch DSC 204F1). The pieces were heated to 320° C. at the rate of 10° C./min, and analyzed to obtain the curve of heat to temperature.

The glass transition temperature (T_{g}) was the temperature at which the material changed between the glass state and the rubber state. The glass transition showed the secondary phase change, and the heat capacity of the gel had continuous changes. The curve of heat to temperature, in which the Y axis indicated heat value (Q or H) and the X axis indicated the temperature (° C.), measured by the DSC machine was determined as normal if the curve was flat without rising up; on the contrary, the curve was determined as abnormal.

(3) Reflow Test

Various electronic products are formed from electronic components via SMT and DIP, and the connection between leads and printed circuit boards is conducted by solders. The solders between electronic components and printed circuit boards need to be fused by a heat source such as a reflow machine. Therefore, the electronic components have to bear heat impact, and the wetting characteristics of leads and solders would affect reliability of products.

Reflow test equipment: SMD 10 SBHAO/TANGTECH EQUIPMENT INC.

The IR reflow temperature profiles of the conventional solder and the lead-free solder were compared to show that processing temperature of the lead-free solder was higher than that of the conventional solder.

The reflow test was performed by the following method.

The LED component test sample was prepared according to the following steps:

(a) bonding: the LED chip was fixed on a stand via bonding gel by a bonder; (b) wire bonding: the wiring was formed on the fixed chip; (c) glue-filling and baking: the above sample was filled with the resin composition, and then backed in an oven (short baking: 120° C. for 1.5 to 2 hours; long baking: 150° C. for 4 to 5 hours); (d) cutting and dispersing: the baked sample was cut and dispersed; and (e) color assortment, inspection and storage: the dispersed LED component was processed for color assortment, inspection and storage.

The LED component sample was soldered on the PCB, and placed on the transportation belt of the detection machine for 5 cycles of heating and cooling in 6 minutes. The 5 cycles of heating and cooling were performed as one reflow test. In the LED industry, one to three reflow tests were generally performed. Upon the reflow test, the LED was conducted to light, and the brightness was measured. When the gel cracked or the LED was failed to light up, the reflow test was failed.

(4) LED Reliability Test

For example, the LED reliability was tested by (a) a temperature shock test, (b) a temperature cycle test, (c) a high temperature/high humidity operation life test, (d) a room temperature life test and (e) a high temperature life test.

(a) Temperature Shock Test:

22 LED component samples were placed in a container for the temperature shock test. In the LED industry, 50/100/200/300 or 300 cycles may be performed for this test.

(b) Temperature Cycle Test:

22 LED component samples were placed in a container for the temperature cycle test. In the LED industry, 50/100/200/300 or 300 cycles may be performed for this test.

(c) high temperature/high humidity operation life test:

22 LED component samples were placed in a container for the high temperature/high humidity operation life test. The test time was measured by hours.

(d) room temperature life test:

22 LED component samples were analyzed for the room temperature life test. Before this test, the optical (such as brightness (mcd)) and electrical (such as positive voltage (v)) characteristics were measured. Then, the optical and electrical characteristics were analyzed at various times, and the decline of the optical and electrical characteristics was observed and recorded.

(e) high temperature life test:

22 LED component samples were analyzed for the high temperature life test. Before this test, the optical (such as brightness (mcd)) and electrical (such as positive voltage (v)) characteristics were measured. Then, the optical and electrical characteristics were analyzed at various times, and the decline of the optical and electrical characteristics was observed and recorded.

The electrical and optical characteristics of the LED component samples were measured according to the above methods.

### COMPARATIVE EXAMPLE 1

| Component | Epoxy resin | Curing agent | Catalyst | Additive |
|---|---|---|---|---|
| wt (%)* | 53.4 | 45 | 0.6 | 1.0 |

*wt (%): weight percentage based on the total weight of the resin composition

Methyl hexahydrophthalic anhydride (MHHPA; Nan Ya Plastics Corporation), methyl tri-n-butylphosphonium dimethylphosphate (catalyst), 0.45 wt % TPP (ChangChun PetroChemical., Co. Ltd.) and 0.55 wt % EV81 (Everlight Chemical Industrial Corporation) were placed in a reactor, and stirred at room temperature. After the catalyst was dissolved, bisphenol A epoxy resin NPEL-127E (Nan Ya Plastics Corporation) was added in the reactor, and stirred at room temperature. Then, the mixture was placed in an oven at 120° C. for 2 hours and at 140° C. for 5 hours to be completely cured.

The resin composition of Comparative Example 1 was analyzed for two TMA tests (FIG. 1A and FIG. 1B), DSC test (FIG. 5, PEG0), the reflow test and the LED reliability test. The results were shown in Table 5.

### COMPARATIVE EXAMPLE 2

| Component | Epoxy resin | Curing agent | Catalyst | PEG600 | Additive |
|---|---|---|---|---|---|
| wt (%)* | 49.2 | 44.1 | 0.6 | 5.1 | 1.0 |

*wt (%): weight percentage based on the total weight of the resin composition

PEG600 (molecular weight: 600), a curing agent (MHHPA), methyl tri-n-butylphosphonium dimethylphosphate and additives (0.45 wt % TPP and 0.55 wt % EV81) were placed in a reactor, and stirred at room temperature. After the catalyst was dissolved, bisphenol A diglycidyl ether resin NPEL-127E (Nan Ya Plastics Corporation) was added in the reactor, and stirred at room temperature. Then, the mixture was placed in an oven at 120° C. for 2 hours and at 140° C. for 5 hours to be completely cured.

The resin composition of Comparative Example 2 was analyzed for two TMA tests (FIG. 2), DSC test (FIG. 5, PEG600), the reflow test and the LED reliability test. The results were shown in Table 5.

### Embodiment 1

| | Component | | | | |
|---|---|---|---|---|---|
| | Epoxy resin | Curing agent | Catalyst | PEG1500 | Additive |
| wt (%)* | 49.2 | 44.1 | 0.6 | 5.1 | 1.0 |

*wt (%): weight percentage based on the total weight of the resin composition

Bisphenol A diglycidyl ether resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PEG1500 (molecular weight 1500) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 1 was analyzed for two TMA tests (FIG. 3), DSC test (FIG. 5,PEG1500), the reflow test and the LED reliability test. The results were shown in Table 5.

### Embodiment 2

| | Component | | | | |
|---|---|---|---|---|---|
| | Epoxy resin | Curing agent | Catalyst | PEG3000 | Additive |
| wt (%)* | 49.2 | 44.1 | 0.6 | 5.1 | 1.0 |

*wt (%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PEG3000 (molecular weight 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 2 was analyzed for two TMA tests (FIG. 4), DSC test (FIG. 5, PEG3000), the reflow test and the LED reliability test. The results were shown in Table 5.

The components of Embodiments 1 and 2 and Comparative Examples 1 and 2 were shown in Table 1.

TABLE 1

| | | | Stress | | |
|---|---|---|---|---|---|
| | | | adjusting | | |
| | | Curing | agent | | |
| Sample | Epoxy resin | agent | (wt %) | Catalyst | Additive |
| Embodiment | NPEL-127E | MHHPA | PEG | + | + |
| 1 | | | 1500 (5.1) | | |
| Embodiment | NPEL-127E | MHHPA | PEG | + | + |
| 2 | | | 3000 (5.1) | | |
| Comparative | NPEL-127E | MHHPA | — | + | + |
| Example 1 | | | | | |
| Comparative | NPEL-127E | MHHPA | PEG | + | + |
| Example 2 | | | 600 (5.1) | | |

### Embodiment 3

| Component | Epoxy resin | Curing agent | Catalyst | PG | Additive |
|---|---|---|---|---|---|
| wt (%)* | 51.6 | 46.3 | 0.6 | 0.5 | 1.0 |

*wt (%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PG were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 3 was analyzed for the TMA test, DSC test, the reflow test and the LED reliability test. The results were shown in Table 5.

### Embodiment 4

| Component | Epoxy resin | Curing agent | Catalyst | PG | Additive |
|---|---|---|---|---|---|
| wt (%)* | 51.5 | 45.8 | 0.6 | 1.5 | 0.6 |

*wt (%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PG were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 4 was analyzed for the TMA test, DSC test, the reflow test and the LED reliability test. The results were shown in Table 5.

### Embodiment 5

| Component | Epoxy resin | Curing agent | Catalyst | PG | Additive |
|---|---|---|---|---|---|
| wt(%)* | 50.6 | 45.3 | 0.6 | 2.5 | 1.0 |

*wt(%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PG were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 5 was analyzed for the TMA test, DSC test, the reflow test and the LED reliability test. The results were shown in Table 5.

### Embodiment 6

| Component | Epoxy resin | Curing agent | Catalyst | PG | Additive |
|---|---|---|---|---|---|
| wt(%)* | 50 | 44.9 | 0.6 | 3.5 | 1.0 |

*wt(%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PG were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 6 was analyzed for the TMA test, DSC test, the reflow test and the LED reliability test. The results were shown in Table 5.

### Embodiment 7

| Component | Epoxy resin | Curing agent | Catalyst | PG | Additive |
|---|---|---|---|---|---|
| wt(%)* | 49.2 | 44.1 | 0.6 | 5.1 | 1.0 |

*wt(%): weight percentage based on the total weight of the resin composition

Bisphenol A epoxy resin NPEL-127E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PG were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 7 was analyzed for the TMA test, DSC test, the reflow test and the LED reliability test. The results were shown in Table 5.

The components of Embodiments 3 to 7 were shown in Table 2.

TABLE 2

| | | | Stress | | |
|---|---|---|---|---|---|
| | | | adjusting | | |
| | | Curing | agent | Addi- | |
| Sample | Epoxy resin | agent | (wt %) | Catalyst | tive |
| Embodiment 3 | NPEL-127E | MHHPA | PG (0.5) | + | + |
| Embodiment 4 | NPEL-127E | MHHPA | PG (1.5) | + | + |
| Embodiment 5 | NPEL-127E | MHHPA | PG (2.5) | + | + |
| Embodiment 6 | NPEL-127E | MHHPA | PG (3.5) | + | + |
| Embodiment 7 | NPEL-127E | MHHPA | PG (5.1) | + | + |

### Embodiment 8

| | Component | | | | |
|---|---|---|---|---|---|
| | Epoxy resin | Curing agent | Catalyst | PPG3000 | Additive |
| wt(%)* | 51.6 | 46.3 | 0.6 | 0.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 8 was analyzed for the TMA test, DSC test, the reflow test and the LED reliability test. The results were shown in Table 5.

### Embodiment 9

| | Component | | | | |
|---|---|---|---|---|---|
| | Epoxy resin | Curing agent | Catalyst | PPG3000 | Additive |
| wt(%)* | 51.3 | 46.1 | 0.6 | 1.0 | 1.0 |

*wt(%): weight percentage based on the total weight of the resin composition

Bisphenol A epoxy resin LAPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 9 was analyzed for the TMA test, DSC test, the reflow test and the LED reliability test. The results were shown in Table 5.

### Embodiment 10

| | Component | | | | |
|---|---|---|---|---|---|
| | Epoxy resin | Curing agent | Catalyst | PPG3000 | Additive |
| wt(%)* | 51.1 | 45.8 | 0.6 | 1.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 10 was analyzed for the TMA test, DSC-test, the reflow test and the LED reliability test. The results were shown in Table 5.

### Embodiment 11

| | Component | | | | |
|---|---|---|---|---|---|
| | Epoxy resin | Curing agent | Catalyst | PPG3000 | Additive |
| wt(%)* | 50.6 | 45.3 | 0.6 | 2.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 11 was analyzed for the TMA test (FIG. 6A), DSC test (FIG. 6B), the reflow test and the LED reliability test. The results were shown in Table 5.

### Embodiment 12

| | Component | | | | |
|---|---|---|---|---|---|
| | Epoxy resin | Curing agent | Catalyst | PPG3000 | Additive |
| wt(%)* | 49.2 | 44.1 | 0.6 | 5.1 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 12 was analyzed for the TMA test, DSC test, the reflow test and the LED reliability test. The results were shown in Table 5.

The components of Embodiments 8 to 12 were shown in Table 3.

TABLE 3

| | | | Stress | | |
|---|---|---|---|---|---|
| | | | adjusting | | |
| | Epoxy | Curing | agent | | Addi- |
| Sample | resin | agent | (wt %) | Catalyst | tive |
| Embodiment 8 | NPEL- | MHHPA | PPG 3000 (0.5) | + | + |
| | 128E | | | | |
| Embodiment 9 | NPEL- | MHHPA | PPG 3000 (1) | + | + |
| | 128E | | | | |
| Embodiment 10 | NPEL- | MHHPA | PPG 3000 (1.5) | + | + |
| | 128E | | | | |
| Embodiment 11 | NPEL- | MHHPA | PPG 3000 (2.5) | + | + |
| | 128E | | | | |
| Embodiment 12 | NPEL- | MHHPA | PPG 3000 (5.1) | + | + |
| | 128E | | | | |

### Comparative Example 3

| Component | Epoxy resin | Curing agent | Catalyst | Additive |
|---|---|---|---|---|
| wt(%)* | 51.9 | 46.5 | 0.6 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PPG3000 (molecular weight: 3000) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 3 was analyzed for the TMA test (FIG. 7A), DSC test (FIG. 7B), the reflow test and the LED reliability test. The results were shown in Table 5.

### COMPARATIVE EXAMPLE 4

| | Component | | | | |
|---|---|---|---|---|---|
| | Epoxy resin | Curing agent | Catalyst | PTMG250 | Additive |
| wt(%)* | 51.6 | 46.3 | 0.6 | 0.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG250 (molecular weight: 250, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 4 was analyzed for the TMA test (FIG. 8A), DSC test (FIG. 8B), the reflow test and the LED reliability test. The results were shown in Table 5.

### COMPARATIVE EXAMPLE 5

| | Component | | | | |
|---|---|---|---|---|---|
| | Epoxy resin | Curing agent | Catalyst | PTMG250 | Additive |
| wt(%)* | 51.3 | 46.1 | 0.6 | 1.0 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG250 (molecular weight: 250, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 5 was analyzed for the TMA test, DSC test, the reflow test and the LED reliability test. The results were shown in Table 5.

### COMPARATIVE EXAMPLE 6

Component

| | Epoxy resin | Curing agent | Catalyst | PTMG250 | Additive |
|---|---|---|---|---|---|
| wt(%)* | 51.1 | 45.8 | 0.6 | 1.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG250 (molecular weight: 250, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 6 was analyzed for the TMA test, DSC test, the reflow test and the LED reliability test. The results were shown in Table 5.

### Comparative Example 7

| | Component | | | | |
|---|---|---|---|---|---|
| | Epoxy resin | Curing agent | Catalyst | PTMG250 | Additive |
| wt(%)* | 50.6 | 45.3 | 0.6 | 2.5 | 1.0 |

*wt(%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG250 (molecular weight: 250, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 7 was analyzed for the TMA test (FIG. 9A), DSC test (FIG. 9B), the reflow test and the LED reliability test. The results were shown in Table 5.

### COMPARATIVE EXAMPLE 8

| | Component | | | | |
|---|---|---|---|---|---|
| | Epoxy resin | Curing agent | Catalyst | PTMG250 | Additive |
| wt (%)* | 49.2 | 44.1 | 0.6 | 5.1 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG250 (molecular weight: 250, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 8 was analyzed for the TMA test (FIG. 10A), DSC test (FIG. 10B), the reflow test and the LED reliability test. The results were shown in Table 5.

### COMPARATIVE EXAMPLE 9

| | Component | | | | |
|---|---|---|---|---|---|
| | Epoxy resin | Curing agent | Catalyst | PTMG650 | Additive |
| wt (%)* | 51.6 | 46.3 | 0.6 | 0.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG650 (molecular weight: 650, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 9 was analyzed for the TMA test (FIG. 11A), DSC test (FIG. 11B), the reflow test and the LED reliability test. The results were shown in Table 5.

### COMPARATIVE EXAMPLE 10

| | Component | | | | |
|---|---|---|---|---|---|
| | Epoxy resin | Curing agent | Catalyst | PTMG650 | Additive |
| wt (%)* | 51.3 | 46.1 | 0.6 | 1.0 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG650 (molecular weight: 650, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 10 was analyzed for the TMA test, DSC test, the reflow test and the LED reliability test. The results were shown in Table 5.

### COMPARATIVE EXAMPLE 11

| | Component | | | | |
|---|---|---|---|---|---|
| | Epoxy resin | Curing agent | Catalyst | PTMG650 | Additive |
| wt (%)* | 51.1 | 45.8 | 0.6 | 1.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG650 (molecular weight: 650, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 11 was analyzed for the TMA test, DSC test, the reflow test and the LED reliability test. The results were shown in Table 5.

### COMPARATIVE EXAMPLE 12

| | Component | | | | |
|---|---|---|---|---|---|
| | Epoxy resin | Curing agent | Catalyst | PTMG650 | Additive |
| wt (%)* | 50.6 | 45.3 | 0.6 | 2.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG650 (molecular weight: 650, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 12 was analyzed for the TMA test (FIG. 12A), DSC test (FIG. 12B), the reflow test and the LED reliability test. The results were shown in Table 5.

### COMPARATIVE EXAMPLE 13

| | Component | | | | |
|---|---|---|---|---|---|
| | Epoxy resin | Curing agent | Catalyst | PTMG650 | Additive |
| wt (%)* | 49.2 | 44.1 | 0.6 | 5.1 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG650 (molecular weight: 650, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 13 was analyzed for the TMA test (FIG. 13A), DSC test (FIG. 13B), the reflow test and the LED reliability test. The results were shown in Table 5.

### COMPARATIVE EXAMPLE 14

| | Component | | | | |
|---|---|---|---|---|---|
| | Epoxy resin | Curing agent | Catalyst | PTMG1000 | Additive |
| wt (%)* | 51.6 | 46.3 | 0.6 | 0.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1000 (molecular weight: 1000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 14 was analyzed for the TMA test (FIG. 14A), DSC test (FIG. 14B), the reflow test and the LED reliability test. The results were shown in Table 5.

### COMPARATIVE EXAMPLE 15

| | Component | | | | |
|---|---|---|---|---|---|
| | Epoxy resin | Curing agent | Catalyst | PTMG1000 | Additive |
| wt (%)* | 51.3 | 46.1 | 0.6 | 1.0 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1000 (molecular weight: 1000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 15 was analyzed for the TMA test, DSC test, the reflow test and the LED reliability test. The results were shown in Table 5.

### Comparative Example 16

| | Component | | | | |
|---|---|---|---|---|---|
| | Epoxy resin | Curing agent | Catalyst | PTMG1000 | Additive |
| wt (%)* | 51.1 | 45.8 | 0.6 | 1.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1000 (molecular weight: 1000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 16 was analyzed for the TMA test, DSC test, the reflow test and the LED reliability test. The results were shown in Table 5.

### COMPARATIVE EXAMPLE 17

| | Component | | | | |
|---|---|---|---|---|---|
| | Epoxy resin | Curing agent | Catalyst | PTMG1000 | Additive |
| wt (%)* | 50.6 | 45.3 | 0.6 | 2.5 | 1.0 |

*wt (%): weight percentage based on the total weight of the resin composition

Bisphenol A epoxy resin LAPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1000 (molecular weight: 1000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 17 was analyzed for the TMA test (FIG. 15A), DSC test (FIG. 15B), the reflow test and the LED reliability test. The results were shown in Table 5.

### COMPARATIVE EXAMPLE 18

| | Component | | | | |
|---|---|---|---|---|---|
| | Epoxy resin | Curing agent | Catalyst | PTMG1000 | Additive |
| wt (%)* | 49.2 | 44.1 | 0.6 | 5.1 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1000 (molecular weight: 1000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Comparative Example 18 was analyzed for the TMA test (FIG. 16A), DSC test (FIG. 16B), the reflow test and the LED reliability test. The results were shown in Table 5.

### Embodiment 13

| | Component | | | | |
|---|---|---|---|---|---|
| | Epoxy resin | Curing agent | Catalyst | PTMG1800 | Additive |
| wt (%)* | 50 | 44.9 | 0.6 | 3.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG1800 (molecular weight: 1800, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 13 was analyzed for the TMA test (FIG. 17A), DSC test (FIG. 17B), the reflow test and the LED reliability test. The results were shown in Table 5.

### Embodiment 14

| | Component | | | | |
|---|---|---|---|---|---|
| | Epoxy resin | Curing agent | Catalyst | PTMG3000 | Additive |
| wt (%)* | 50.6 | 45.3 | 0.6 | 2.5 | 1.0 |

*wt (%): weight percentage based on the total weight of the resin composition

Bisphenol A epoxy resin NPEL-128E (Nan Ya Plastics Corporation), MHHPA (curing agent), methyl tri-n-butylphosphonium dimethylphosphate (catalyst) and an additive (0.45 wt % TPP from ChangChun PetroChemical., Co. Ltd. and 0.55 wt % EV81 from Everlight Chemical Industrial Corporation) were provided. The curing agent, the catalyst, the additive and the stress adjusting agent PTMG3000 (molecular weight: 3000, Formosa Asahi Spandex Co., Ltd.) were placed in a reactor, and stirred at room temperature. After the catalyst was dissolved, the epoxy resin was added in the reactor, and stirred at room temperature. Then, the mixture was placed in an oven at 120° C. for 2 hours and at 140° C. for 5 hours to be completely cured.

The resin composition of Embodiment 14 was analyzed for the TMA test (FIG. 18A), DSC test (FIG. 18B), the reflow test and the LED reliability test. The results were shown in Table 5.

The components of Comparative Examples 3-18 and Embodiments 13-14 were shown in Table 4.

TABLE 4

| | | | Stress adjusting | | |
|---|---|---|---|---|---|
| Sample | Epoxy resin | Curing agent | agent (wt %) | Catalyst | Additive |
| Comparative | NPEL-128E | MHHPA | — | + | + |
| Example 3 | | | | | |
| Comparative | NPEL-128E | MHHPA | PTMG 250 (0.5) | + | + |
| Example 4 | | | | | |
| Comparative | NPEL-128E | MHHPA | PTMG 250 (1.0) | + | + |
| Example 5 | | | | | |
| Comparative | NPEL-128E | MHHPA | PTMG 250 (1.5) | + | + |
| Example 6 | | | | | |
| Comparative | NPEL-128E | MHHPA | PTMG 250 (2.5) | + | + |
| Example 7 | | | | | |
| Comparative | NPEL-128E | MHHPA | PTMG 250 (5.1) | + | + |
| Example 8 | | | | | |
| Comparative | NPEL-128E | MHHPA | PTMG 650 (0.5) | + | + |
| Example 9 | | | | | |
| Comparative | NPEL-128E | MHHPA | PTMG 650 (1.0) | + | + |
| Example 10 | | | | | |
| Comparative | NPEL-128E | MHHPA | PTMG 650 (1.5) | + | + |
| Example 11 | | | | | |
| Comparative | NPEL-128E | MHHPA | PTMG 650 (2.5) | + | + |
| Example 12 | | | | | |
| Comparative | NPEL-128E | MHHPA | PTMG 650 (5.1) | + | + |
| Example 13 | | | | | |
| Comparative | NPEL-128E | MHHPA | PTMG 1000 (0.5) | + | + |
| Example 14 | | | | | |
| Comparative | NPEL-128E | MHHPA | PTMG 1000 (1.0) | + | + |
| Example 15 | | | | | |
| Comparative | NPEL-128E | MHHPA | PTMG 1000 (1.5) | + | + |
| Example 16 | | | | | |
| Comparative | NPEL-128E | MHHPA | PTMG 1000 (2.5) | + | + |
| Example 17 | | | | | |
| Comparative | NPEL-128E | MHHPA | PTMG 1000 (5.1) | + | + |
| Example 18 | | | | | |
| Embodiment 13 | NPEL-128E | MHHPA | PTMG 1800 (3.5) | + | + |
| Embodiment 14 | NPEL-128E | MHHPA | PTMG 3000 (2.5) | + | + |

The results of the TMA tests, the DSC tests, the reflow tests and the LED reliability tests in Embodiments 13-14 and Comparative Examples 3-18 were shown in Table 5.

TABLE 5

| | Stress adjusting | TMA | DSC | Reflow | LED |
|---|---|---|---|---|---|
| Sample | agent (wt %) | test | test | test | reliability test |
| Comparative | — | α₂/α₁ > 3 | flat curve | x | x |
| Example 1 | | | | | |
| Comparative | PEG 600 | α₂/α₁ > 3 | flat curve | ∘ | x |
| Example 2 | (5.1) | | | | |
| Embodiment 1 | PEG 1500 | α₂/α₁ > 3 | flat curve | ∘ | ∘ |
| | (5.1) | | | | |
| Embodiment 2 | PEG 3000 | α₂/α₁ < 3 | flat curve | ∘ | ∘ |
| | (5.1) | | | | |
| Embodiments 3-7 | PG | α₂/α₁ < 3 | flat curve | ∘ | x |
| | (0.5-5.1) | | | | |
| Embodiments 8-12 | PPG 3000 | α₂/α₁ < 3 | flat curve | ∘ | ∘ |
| | (0.5-5.1) | | | | |
| Comparative | — | α₂/α₁ < 3 | uneven curve | x | x |
| Example 3 | | | | | |
| Comparative | PTMG 250 | α₂/α < 3 | flat curve | ∘ | x |
| Example 4-8 | (0.5-5.1) | | | | |
| Comparative | PTMG 650 | α₂/α < 3 | flat curve | ∘ | x |
| Example 9-13 | (0.5-5.1) | | | | |
| Comparative | PTMG 1000 | α₂/α < 3 | flat curve | ∘ | x |
| Example 14-18 | (0.5-5.1) | | | | |
| Embodiment 13 | PTMG 1800 | α₂/α₁ < 3 | flat curve | ∘ | ∘ |
| | (3.5) | | | | |
| Embodiment 14 | PTMG 3000 | α₂/α₁ < 3 | flat curve | ∘ | ∘ |
| | (2.5) | | | | |

∘: the test passed;
x: the test failed.

As shown in Table 5, the resin compositions of Comparative Examples 1 and 3 included no stress adjusting agent, and had α₂/α₁ more than 3, which indicated that the expansion coefficients of the resin compositions changed significantly before and after the glass transition temperature, and thus the stress occurred easily. In addition, the uneven curves of the DSC tests indicated that the LED encapsulation gels had poor thermal stability. The LED encapsulation gels formed from the resin compositions having no stress adjusting agent failed to pass the reflow test and the LED reliability test. In contrast, the resin compositions of Embodiments 1-14 included stress adjusting agents, had α₂/α₁ less than 3 in the TMA tests and flat curves in the DSC tests, and passed the reflow tests and the LED reliability tests. Therefore, the addition of the stress adjusting agent effectively reduced the expansion coefficient of the resin composition before and after the glass transition temperature, effectively reduced the stress, and improved the LED reliability. In Comparative Example 2, the resin composition included PEG600 (weight average molecular weight: 600) and had α₂/α₁ more than 3 in the TMA test, which indicated that the expansion coefficient of the resin compositions changed significantly before and after the glass transition temperature, and thus the stress occurred easily. Further, in Comparative Example 2, the LED encapsulation gel formed from such resin composition failed to pass the LED reliability test. In Embodiments 1 and 2, the resin composition included PEG1500 and PEG3000, respectively, and had α₂/α₁ less than 3 in the TMA tests and the flat curves in the DSC tests. In Embodiments 1 and 2, the LED encapsulation gels formed from such resin compositions passed the reflow tests and the LED reliability tests. Therefore, the addition of PEG (weight average molecular weight more than 1000) as the stress adjusting agent effectively reduced stress and improved the LED reliability.

In Comparative Examples 4-18, the resin composition included PTMG (weight average molecular weight less than 1000), and had α₂/α₁ less than 3 in the TMA tests. In Comparative Examples 4-18, the LED encapsulation gels formed from such resin compositions failed to pass the LED reliability tests. In contrast, in Embodiments 13 and 14, the resin composition included PTMG (weight average molecular weight more than 1000), and had α₂/α₁ less than 3 in the TMA tests and the flat curves in the DSC tests. In Embodiments 13 and 14, the LED encapsulation gels formed from such resin compositions passed the reflow tests and the LED reliability tests. Hence, the addition of the PTMG (weight average molecular weight more than 1000) as the stress adjusting agent reduced stress and improved the LED reliability.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A resin composition, comprising:
43 to 53 wt % of an epoxy resin based on total weight of the resin composition;
40 to 47 wt % of a curing agent based on the total weight of the resin composition; and
0.5 to 10 wt % of a stress adjusting agent based on the total weight of the resin composition, wherein the stress adjusting agent is one or more selected from the group consisting of ethylene glycol, propylene glycol, polyethylene glycol, polypropylene glycol and polytetramethylene ether glycol.

2. The resin composition of claim 1, wherein the epoxy resin is one or more selected from the group consisting of bisphenol A epoxy resin, silicon-containing epoxy resin and aliphatic epoxy resin.

3. The resin composition of claim 1, wherein weight average molecular weight of the epoxy resin is 200 to 3000.

4. The resin composition of claim 1, wherein the curing agent is an anhydride curing agent.

5. The resin composition of claim 1, wherein the stress adjusting agent is ethylene glycol, propylene glycol or a combination thereof.

6. The resin composition of claim 1, wherein the stress adjusting agent is one or more selected from the group consisting of polyethylene glycol, polypropylene glycol and polytetramethylene ether glycol, and has weight average molecular weight of 1500 to 3000.

7. The resin composition of claim 6, wherein the stress adjusting agent is polyethylene glycol, and weight average molecular weight of the polyethylene glycol is 1500 to 3000.

8. The resin composition of claim 6, wherein the stress adjusting agent is polypropylene glycol, and weight average molecular weight of the polypropylene glycol is 2000 to 3000.

9. The resin composition of claim 6, wherein the stress adjusting agent is polytetramethylene ether glycol, and weight average molecular weight of the polytetramethylene ether glycol is 1800 to 3000.

10. The resin composition of claim 1, being used for LED encapsulation.

11. The resin composition of claim 1, further comprising 0.5 to 5 wt % of a catalyst based on the total weight of the resin composition.

12. The resin composition of claim 1, further comprising an additive.
